(19) United States
(12) Patent Application Publication
(10) Pub. No.: US 2012/0017095 A1
(43) Pub. Date: Jan. 19, 2012

(54) Software Service for Encrypting and Decrypting Data

(75) Inventors: Kevin Paul Blenkhorn, Arlington, VA (US); Raymond Todd Schenk, Roswell, GA (US); Ari Blenkhorn, Arlington, VA (US)

(73) Assignee: COREGUARD, Roswell, GA (US)

(21) Appl. No.: 13/185,696

(22) Filed: Jul. 19, 2011

Related U.S. Application Data
(60) Provisional application No. 61/365,682, filed on Jul. 19, 2010.

(51) Int. Cl. G06F 12/14

(52) U.S. Cl. 713/189

(57) ABSTRACT

A system for making encryption and decryption available to software applications as a service is disclosed. An encryption/decryption server verifies the credentials of human operators, hardware devices, or combinations of operators and hardware devices and determines the cryptographic keys to which they have access, and provides access to said keys. Client software applications send service requests to the encryption/decryption server to encrypt or decrypt data. The server encrypts or decrypts the data as requested if the operator or device has the proper credentials to access the required key. The system may include multiple levels of security access.

### CROSS REFERENCE TO RELATED APPLICATIONS

The benefit of the filing date of U.S. Provisional Patent Application Ser. No. 61/365,682, filed Jul. 19, 2010, entitled “Software Service for Encrypting and Decrypting Data,” is hereby claimed, and the specification thereof is incorporated herein in its entirety by this reference.

### TECHNICAL FIELD

This invention relates in general to application software, and more particularly to software, systems, and methods for providing application services for encryption and decryption.

### BACKGROUND

Businesses and individuals who use computers are often at risk of their private data being stolen. Any file stored on a hard drive or removable media device can potentially be read or copied. Unauthorized access and duplication (“data theft”) can be carried out by hackers, viruses, or duplicitous personnel.

Theft of private data can be devastating. For a business, stolen information can release intellectual property or trade secrets that have financial value. A company may spend millions of dollars researching a new invention, only to find the results of their research being used by their competitors at no cost. For individuals, a loss of data from a personal computer can lead to financial ruin or identify theft. Many people keep banking information and passwords on their computers; acquiring this data could enable a thief to open a new credit card or transfer money from their accounts.

If a file is stored on a hard drive or other digital storage medium, the information in the file can be read by anyone with access to the device. Old hard drives are often thrown away when computers are discarded as obsolete. The data in their drives may be readable for decades. Even after a file has been deleted, forensic procedures exist to recover the file partially or entirely.

The primary method for preventing data theft from a computer is to restrict access to the machine, thus preventing hostile parties from unauthorized entry. Computer-owners generally do this by using firewalls and following network security procedures. This is analogous to keeping thieves out of a house by locking the windows and doors. It works to keep some intruders out. However, if a hostile party penetrates this perimeter, these methods present no further barrier to keep him from stealing the data.

A good secondary method for preventing data loss is to encrypt the data. Encryption algorithms convert human-readable text into data that is unreadable except by a person with the secret key. If data files are encrypted on disk, then a thief will not gain any useful information even if he is able to access the files. The problem with encryption is that most common methods for applying it are cumbersome and time-consuming.

Encryption is most commonly applied to an entire hard disk, especially on laptop computers. Laptop computers are small, high-value items that are easily stolen. The intellectual property on the laptop computer's hard drive is often worth more to the company than the computer itself. To prevent data loss in the event of laptop computer theft, many people encrypt their hard drives whenever the laptop computer is shut down; preventing the thief from being able to access any files on the hard drive. While this defense mechanism has value, it also has a manpower cost. The entire hard drive must be encrypted on shutdown and decrypted on the next startup. This takes a considerable amount of time, often between 10-30 minutes, and is an inconvenience to a human operator. Many people cease using this feature, since it prevents them from being able to access their computer quickly. Whole-disk encryption has a cost to the employer, since an employee's productivity is limited while his laptop computer is being encrypted or decrypted. Finally, this type of disk encryption only protects the information while the computer is encrypted and shut down. It does not protect the files while the computer is running and unencrypted. It does not prevent a remote hacker or virus from stealing unencrypted files while the computer is powered up.

While the value of encrypting files is undeniable, there are few tools available that allow a human operator or hardware device to encrypt a single file or a portion of a single file. The available tools for encrypting entire disks are cumbersome and do not protect the data while the computer is running. Accordingly, improvements in the availability of data encryption tools are needed to improve security and usability.

### SUMMARY

Various embodiments of methods for providing a software service for encrypting and decrypting data are disclosed. One embodiment is a method for enabling encryption and decryption of data as a service. The method comprises the steps of providing an encryption/decryption engine, verifying an identifier, providing a repository and directing the encryption/decryption engine to process requests from a verified source associated with the identifier to encrypt or decrypt data using an appropriate key from the repository.

An alternative method for transforming data communicated in a first format includes the steps of receiving a formatted request with data from an application, identifying a source of the formatted request, determining whether the source is associated with an appropriate access level, and when the source is associated with an appropriate access level and a key for processing data at the access level is available, using an encryption/decryption engine to process the formatted request such that data received in the first format is translated to and communicated in a second format that is different from the first format.

### BRIEF DESCRIPTION OF THE DRAWINGS

These and other objects, features, elements and advantages of the software service for encrypting and decrypting data will be more readily apparent from the following detailed description of the illustrated embodiments, in which:

FIG. 1 schematically illustrates an embodiment of a system for encrypting and decrypting data;

FIG. 2 schematically illustrates an alternative embodiment of a system for encrypting and decrypting data;

FIGS. 3A & 3B are a flow chart illustrating an embodiment of a method for encrypting or decrypting data that can be enabled by the system of FIG. 1; and

FIGS. 4A & 4B are a flow chart illustrating an embodiment of a method for encrypting or decrypting data that can be enabled by the system of FIG. 2.

### DETAILED DESCRIPTION

The above described problems with conventional approaches are suffered by both businesses and individuals who want to protect the private data on their computers. The above described problems are overcome in an illustrative embodiment of systems and methods for encrypting and decrypting data in which a server application provides encryption and/or decryption capabilities to multiple third-party applications, allowing them to encrypt and decrypt data files and/or portions of data files to protect information from being readable while the information is in use or when the information is being stored.

The present systems and methods apply to both software applications that are accessed by a human operator, and to applications that are run by a hardware device, with or without human intervention. The term “user” in this patent relates to a human operator, a hardware device, or a software entity that uses the described technology.

Software applications can be run in different ways on a computer. For example, the executable statements that comprise or otherwise enable an encryption/decryption service can be integrated with source code in a software program. By way of further example, the executable statements or program that comprise or otherwise enable the encryption/decryption service can be statically or dynamically linked, as in a dynamic linked library or a static linked library. Linked libraries whether statically or dynamically linked, are modules that contain a function or functions and data that can be used by another module, such as an application or another linked library. Software applications, such as the encryption/decryption service can also be executed as a separate program and in some embodiments can be executed on a computing device separate from a user of the encryption/decryption service.

A “service” library is a set of computer instructions or code that can be used by other software either by: direct insertion or integration into source code; with “include” statements or other library attachment methods; and/or linked either statically or dynamically in the software linking process.

A library attachment allows added “services” to be accessed as part of a software program's executable machine code.

A “server” application is a program that operates as a socket listener. It provides some service in response to requests from “client” applications. In theory, any computer process that shares a resource to one or more client processes is a server. One common example of a server application is a web server. The simplest web servers listen for requests for web pages and respond by replying to the request with the appropriate HTML file. The function of taking page requests and responding with HTML pages is the web server's “service.”

In various embodiments described herein, single-file encryption and sub-file encryption can be achieved via an application library or service.

In one embodiment, a server library linked into an application on a local workstation or on a hardware device provides encryption and decryption services. In other embodiments, the server provides these services as an application on a local workstation or on a hardware device, across a Local Area Network, Wide Area Network, the Internet, or some other type of network. The service can provide multiple encryption algorithms, including both symmetric and asymmetric algorithms.

When operating as an independent server application, separate client applications can contact the encryption server to encrypt and decrypt data. The data can be any sort that can be secured by the encryption type, including text documents, spreadsheets, and imagery. Programs can save their files with encrypted data rather than in readable formats. The client applications can access the server when opening a data file to determine which data elements the user has access rights to read, and to decrypt only the data that the user is supposed to access.

In one aspect of the present systems and methods for encrypting and decrypting data, the server application receives a request in the form of a data packet, whereupon the server application encrypts or decrypts a portion of the data packet and returns it to the sending program.

In another aspect of the present systems and methods for encrypting and decrypting data, the server program stores user information during a login process and retrieves the key or keys required for encryption and decryption. The server may access one or more encryption keys, and may choose to vary the keys made available to the user based on the user's level of access.

In another aspect of the invention, the keys made available to the user may not be accessed until actually needed, or provided for varying lengths of time based upon preset administrative policies configured within the system. Key names and other parameters may be provided to the user without actually accessing the appropriate key until absolutely necessary.

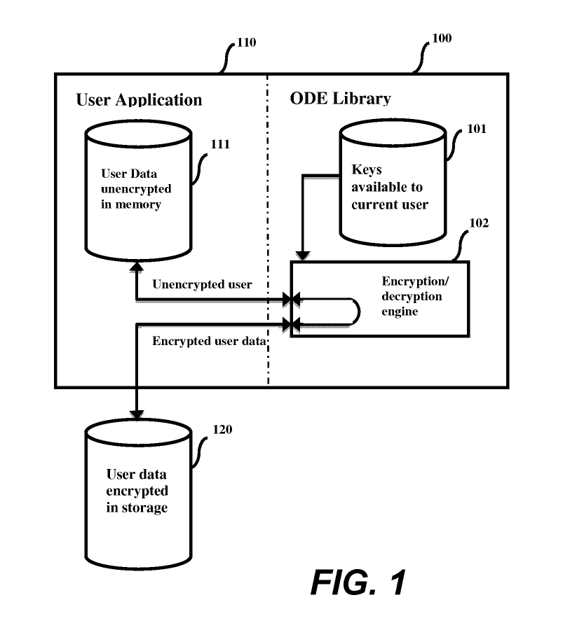

Referring to the drawings, wherein like reference numbers refer to like parts, FIG. 1 illustrates an example embodiment of a system for encrypting and decrypting data.

An “On-Demand Encryption” (ODE) library 100 is running as an included or linked library of executable code. In a preferred embodiment, as shown in FIG. 1, the ODE library 100 is running on the user's local computer. The ODE library 100 has a list of encryption keys available in a key repository 101. The keys in the key repository 101 are appropriate to the type of encryption algorithms available in the encryption/decryption engine 102. The keys available in the key repository 101 are the subset of known keys that are available to the user based on the user's security access level. The encryption/decryption engine 102 contains one or more encryption algorithms. The encryption/decryption engine 102 also contains one or more decryption algorithms. In a preferred embodiment, it contains multiple algorithms, including both symmetric and asymmetric encryption and decryption algorithms.

User application 110 is running on the user's local computer. This can be any application that processes data from a hard disk, database, or other data source. While the user application 110 is running, it operates on unencrypted data in data store 111. When the user's data is saved to disk, database, or any other storage device, it is saved in an encrypted form in data store 120.

When the user application 110 loads data from file, database, or other storage medium such as the data store 120, it converts the information from an encrypted format to an unencrypted format for processing data in data store 111 by processing it through the encryption and decryption engine 102. The user application 110 reads the stored encrypted data from data store 120 and sends a decryption request to the ODE library 100. The ODE library 100 reads the request and determines whether it has the appropriate key in repository 101 to decrypt the data. If it has the appropriate key in repository 101, the ODE library 100 decrypts the data in the encryption and decryption engine 102, using the appropriate stored key in the repository 101. The ODE library 100 then returns a data packet with the decrypted user data, which is stored in data store 111 and available for use by the user application 110.

When the user application 110 saves data to a file, database, or other storage medium, such as data store 120, it converts the information from its unencrypted form to an encrypted form by processing it through the encryption and decryption engine 102. The user application 110 sends the unencrypted data from the data store 111 with an encryption request to the ODE library 100. The ODE library 100 reads the request and determines whether it has the appropriate key in repository 101 to encrypt the data. If it has the appropriate key in repository 101, the ODE library 100 encrypts the data in the encryption and decryption engine 102, using the stored key from the repository 101. The ODE library 100 then returns a data packet with the encrypted user data to the user application 110. The user application 110 stores the encrypted data in data store 120.

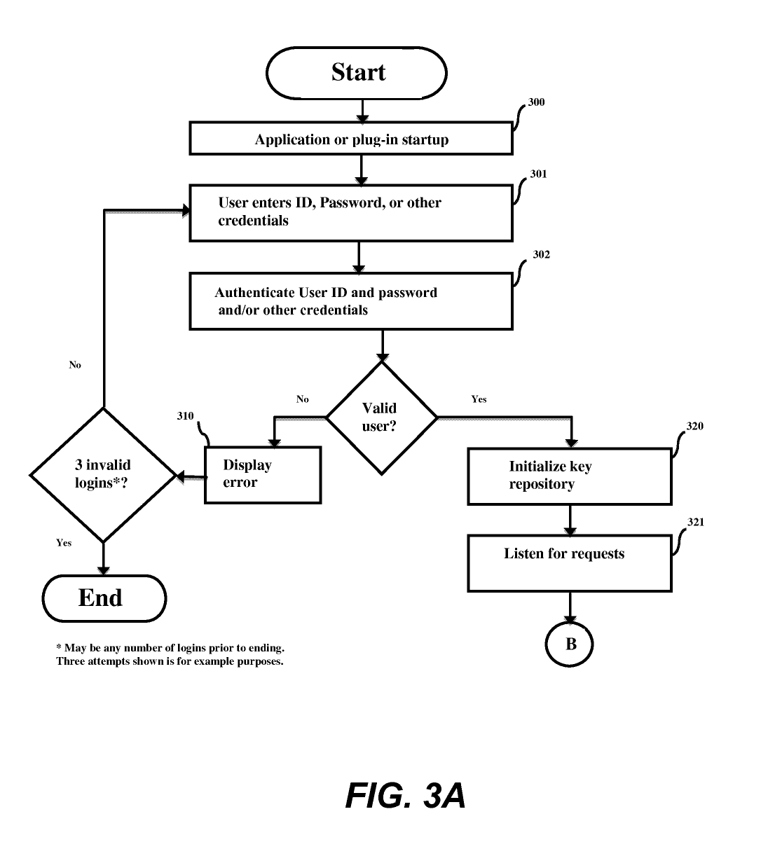

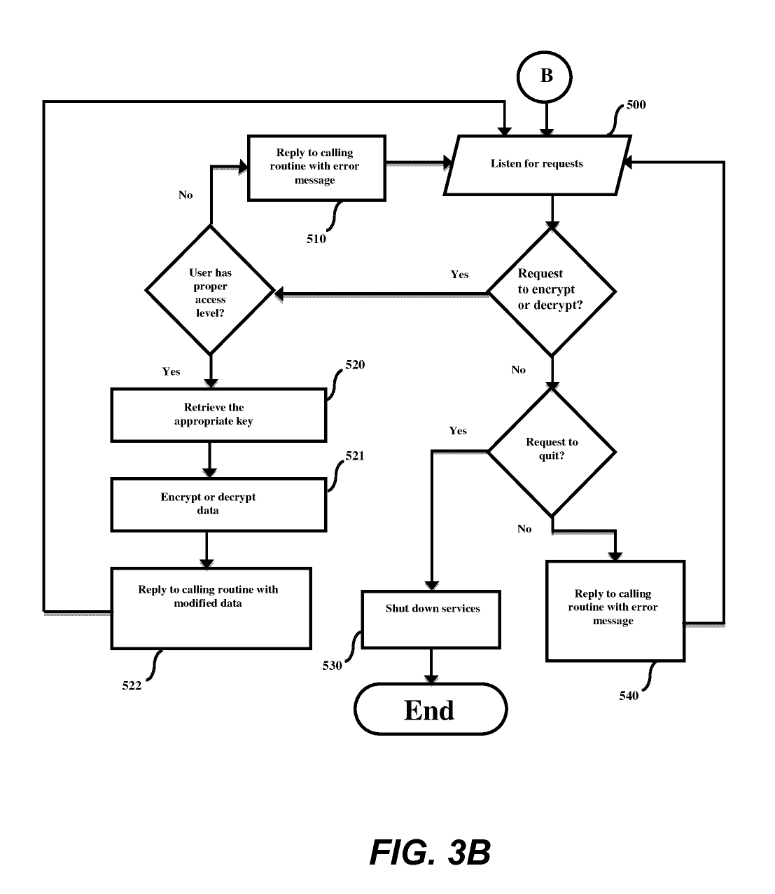

Illustrative operation of the invention is described in FIGS. 3A & 3B. The ODE library 100 can start operation shown in block 300 by manual initiation from the user, automatic initiation when the application starts, automatic initiation when the user logs in, or through some other mechanism. In the illustrated embodiment, the user enters an identifier, password or other credentials as indicated in block 301. In other embodiments, the user may communicate his identify with a smartcard, security token, Public Key Infrastructure element, biometric information, digital recognition signature, or some other security mechanism. In one embodiment, the system may be configured so as to not require any verification of identity by the user. The type of verification required may be determined based on the security requirements of the specific application of the technology. The user identification information, if used, is sent for verification in block 302 where the user identifier, password or other credentials. The verification or authentication, if required, may be performed within the ODE library 100, or it may be performed by either a local (e.g., directly coupled) or network coupled verification server. If the user verification fails, as indicated by the flow control arrow labeled, “NO” exiting the decision block immediately adjacent to block 302, the ODE library 100 displays an error message, as shown in block 310, indicating that the login credentials were invalid. The ODE library 100 may prompt the user to re-enter his credentials or may shut down. In the illustrated embodiment, the ODE library 100 requests the user for his credentials up to three times and shuts down after a failed third attempt. In other embodiments, the ODE library 100 may shut down after some other number of failed login attempts, or may never shut down due to multiple failed login attempts.

Following a successful login by the user, as indicated by the flow control arrow labeled “YES,” exiting the decision block immediately adjacent to block 302, the ODE library 100 initializes its key repository as indicated in block 320. The key repository 101 includes the keys that the user is authorized to access based on his security level, and which he may require during the current transaction. The keys may be stored locally within the ODE library 100, or may be accessible via a remote key management server. In a preferred embodiment, the keys are kept in a networked key management server until requested by the user application. The initialization step in this embodiment verifies that the ODE library 100 can connect to the key management server, and that the keys are available for access. In other embodiments, the keys may be stored in a local key management server on the user's computer, stored in a database, stored in a file, or entered manually by the user. In the preferred implementation, the keys are stored encrypted when saved in a storage medium so as to minimize their risk of theft.

The ODE library 100 is accessed by procedure and function calls in the form of requests from within the user client application, as indicated in block 321. The ODE library 100 then listens or waits for requests for service from the user application routines, as indicated in input/output block 500 (FIG. 3B).

When the ODE library 100 is listening for requests, as indicated in input/output block 500 and receives a request for encrypting or decrypting a data packet, it determines whether the user has the required access and key available for encrypting or decrypting the data. If not, then the ODE library 100 replies to the client application with an error message indicating that the user does not have the required access level, as shown in block 510. If the user does have the proper access level, then the ODE library 100 retrieves the appropriate key from the repository 101 or key management system, as indicated in block 520. Thereafter, the ODE library 100 encrypts or decrypts the data with the key as shown in block 521. In some embodiments, the appropriate access level is interpreted by the encryption/decryption engine such that multiple keys are applied to data that is to be secured at different security levels. Next, as shown in block 522, the ODE library 100 replies to the client application with the newly modified data. The method then returns to input/output block 500 to listen for new requests.

When the ODE library 100 is listening for requests 500 and receives a request to quit, it shuts down services, as indicated in block 530.

When the ODE library 100 is listening for requests and receives a request that it does not recognize, it replies to the client application with an error message indicating that the request was not understood, as indicated in block 540. The ODE library 100 then returns to input/output block 500 to listen for new requests.

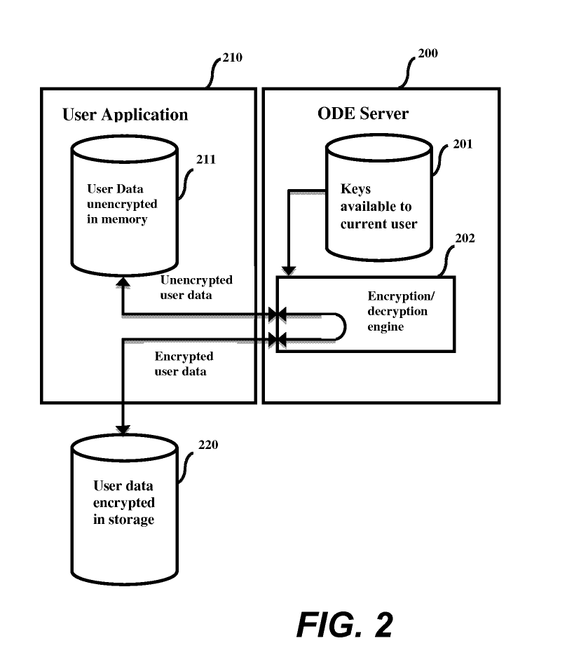

FIG. 2 illustrates an alternate embodiment of a system for encrypting and decrypting data. An “On-Demand Encryption” (ODE) server 200 is provided on the user's local computer or on a remote computer that is reachable from the user's local computer via a Local Area Network, Wide Area Network, or other similar network. The ODE server 200 has a set of encryption keys available in repository 201. The keys are appropriate to the type of encryption algorithms available in the encryption/decryption engine 202. The keys in the repository 201 are available to the user based on the user's security access level. The encryption/decryption engine 202 contains one or more encryption algorithms and associated decryption algorithms. In a preferred embodiment, the encryption/decryption engine 202 contains multiple algorithms, including both symmetric and asymmetric encryption algorithms.

User application 210 is running on the user's local computer. The user application 210 can be any application that processes data from a hard disk, database, or other data source. While the user application 210 is running, it operates on unencrypted data from data store 211. When the user's data is saved to disk, database, or any other storage device, the data is saved in an encrypted form in data store 220. While illustrated as separate data stores, the data store 211 (holding data in an unencrypted format) and the data store 220 (holding data in an encrypted format) can be portions of a single storage device.

When the user application 210 loads data from file, database, or other storage medium, such as data store 220, the user application directs the conversion of the information from an encrypted form or cipher text, as stored in data store 220 to an unencrypted form or clear text in data store 211 by processing it through the encryption and decryption engine 202. The user application 210 reads the stored encrypted data in data store 220 and sends a decryption request to the ODE server 200. The ODE server 200 reads the request and determines whether it has the appropriate key in repository 201 to decrypt the data. If the repository 201 has the appropriate key, the ODE server 200 decrypts the data in the encryption and decryption engine 202, using the stored key from the repository 201. The ODE server 200 then returns a data packet with the decrypted user data to the user application 210.

When the user application 210 saves data to a file, database, or other storage medium, such as data store 220, the user application directs the conversion or transformation of the information from the unencrypted form in data store 211 to an encrypted form by processing it through the encryption and decryption engine 202. The user application 210 sends the unencrypted data from the data store 211 with an encryption request to the ODE server 200. The ODE server 200 receives the request and determines whether it has access to the appropriate key from the repository 201 to encrypt the data. When the repository 201 has the appropriate key, the ODE server 200 retrieves the key and encrypts the data in the encryption and decryption engine 202, using the stored key. The ODE server 200 then returns a data packet with the encrypted user data to the user application 210. The user application 210 stores the encrypted data in its chosen medium.

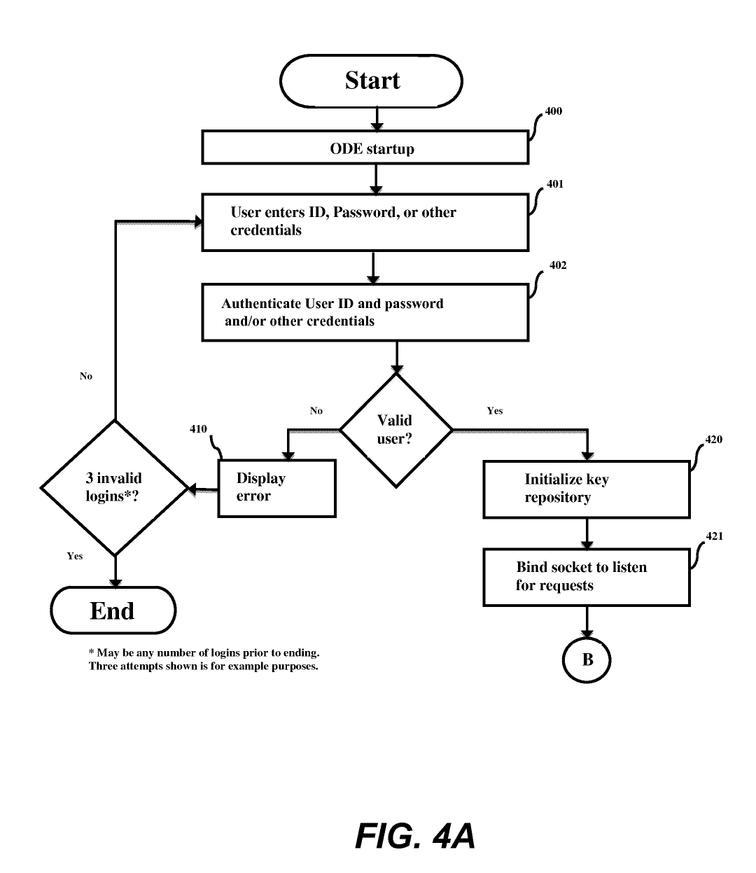

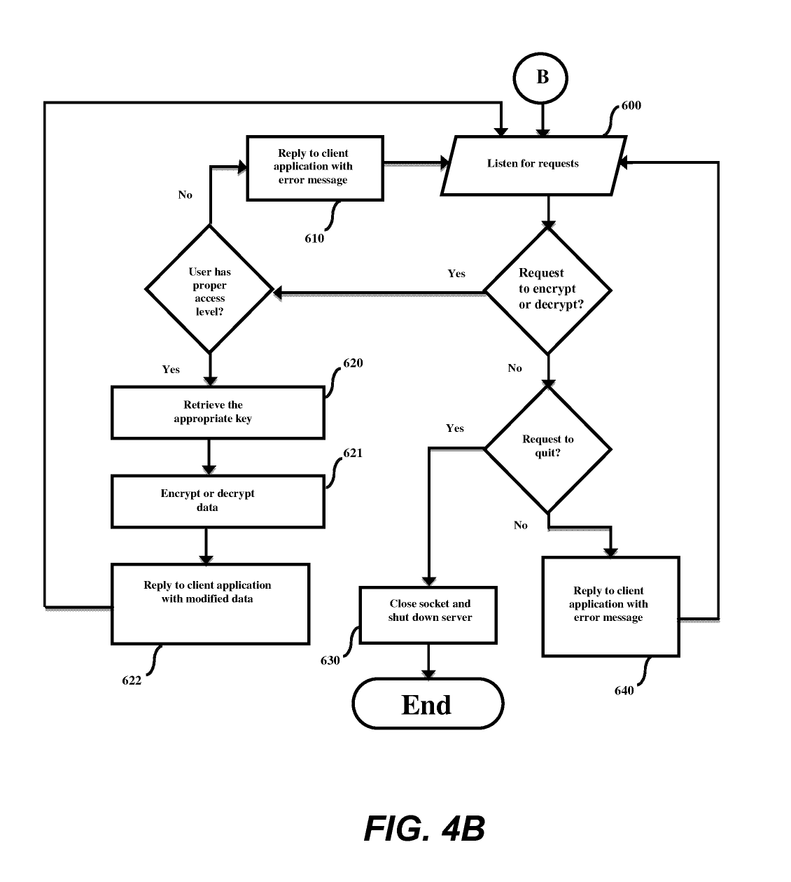

Illustrative operation of the invention is described in FIGS. 4A & 4B. The ODE server 200 can start operation 400 by manual initiation from the user, automatic initiation when the computer boots, automatic initiation when the user logs in, or through some other mechanism. In the illustrated embodiment, the user enters an identifier, password, or other credentials, as indicated in block 401. In other embodiments, the user may verify his identify with a smartcard, security token, Public Key Infrastructure element(s), information from a biometric scan, digital recognition signature, or some other security token. In one embodiment the system may be configured so as to not require any verification of identity by the user. The type of verification required may be determined based on the security requirements of the specific application of the technology. The user identification information, if used, is authenticated, as indicated in block 402. The verification, if required, may be performed within the ODE server 200, or it may be performed by either a local or network-coupled verification server. If the user verification fails, the ODE server 200 displays an error message indication that the login credentials were invalid, as shown in block 410. The ODE server 200 may prompt the user to re-enter his credentials or may shut down. In an embodiment, the ODE server 200 requests the user for his credentials up to three times and shuts down after a failed third attempt. In other embodiments, the ODE server 200 may shut down after some other number of failed login attempts, or may never shut down due to multiple failed login attempts.

Following a successful login by the user, the ODE server 200 initializes its key repository 201, as shown in block 420. The key repository 201 includes the keys that the user is authorized to access based on his security level, and which he may require during the current data transformation transaction. The keys may be stored locally within the ODE server 200, or may be accessible via a remote key management server. In a preferred embodiment, the keys are kept in a networked key management server until requested by the user application. The initialization step, in this embodiment, verifies that the ODE server 200 can connect to the key management server, and that the keys are available for access. In other embodiments, the keys may be stored in a local key management server on the user's computer, stored in a database, stored in a file, or entered manually by the user. In the preferred implementation the keys are stored encrypted when saved in a storage medium so as to minimize their risk of theft.

The ODE server 200 binds itself to a socket so as to be reachable by user client application, as shown in block 421. The ODE server 200 then listens for requests for service from the user applications, as shown in input/output block 600.

When the ODE server 200 is listening for requests, as shown in input/output block 600 and receives a request for encrypting or decrypting a data packet, the ODE server 200 determines whether the user has the required access and key available for encrypting or decrypting the data. If not, then the ODE server 200 replies to the client or user application 210 with an error message, as shown in block 610, indicating that the user does not have the required access level. If the user does have the proper access level, then the ODE server 200 retrieves the appropriate key from the key management system. In some embodiments, the appropriate access level is interpreted by the encryption/decryption engine to translate data at multiple security levels by applying multiple keys associated with security levels. Thereafter, the encryption/decryption engine 202 encrypts or decrypts the data with the key as shown in block 621. Then, the ODE server 200 replies to the client or user application 210 with the newly modified data, as indicated in block 622. The ODE server 200 then returns to input/output block 600 to listen for new requests.

When the ODE server 200 is listening for requests and receives a request to quit, it closes the server socket and shuts down the server, as shown in block 630.

When the ODE server 200 is listening for requests and receives a request that it does not recognize, it replies to the client or user application 210 with an error message indicating that the request was not understood, as shown in block 340. Thereafter, the method returns to input/output block 600 to listen for new requests.

What is claimed is:

1. A method for enabling encryption and decryption of data as a service, said method comprising the steps of:
providing an encryption/decryption engine;
verifying an identifier;
providing a repository; and
directing the encryption/decryption engine to process requests from a verified source associated with the identifier to encrypt or decrypt data using an appropriate key from the repository.

2. The method of claim 1, wherein the step of verifying an identifier further comprises verifying an identified user's access level.

3. The method of claim 2, wherein the identified user's access level is used in a determination to decrypt data and return the same to a user application.

4. The method of claim 2, wherein the identified user's access level is used in a determination to encrypt data and communicate the same to a data store accessible to a user application.

5. The method of claim 1, wherein the repository is communicatively coupled to the encryption/decryption engine using a network protocol.

6. The method of claim 1, wherein providing an encryption/decryption engine further comprises one of including source code in a program, linking a library, and executing a program on a user accessible computing device.

7. The method of claim 6, wherein linking a library further comprises one of a static link or a dynamic link.

8. A method for transforming data communicated in a first format, said method comprising the steps of:
receiving a formatted request with data from an application;
identifying a source of the formatted request;
determining whether the source is associated with an appropriate access level; and
when the source is associated with an appropriate access level and a key for processing data at the access level is available, using an encryption/decryption engine to process the formatted request such that data received in the first format is translated to communicated in a second format that is different from the first format.

9. The method of claim 8, wherein the formatted request is communicated using a network protocol.

10. The method of claim 8, wherein the step of identifying a source comprises one of identifying a user, identifying a device, or identifying a combination of a user and a device.

11. The method of claim 8, wherein an identified source's access level is used in a determination to decrypt data and return the same to a user application.

12. The method of claim 8, wherein the identified source's access level is used in a determination to encrypt data and communicate the same to a data store accessible to a user application.

13. The method of claim 8, wherein a repository is communicatively coupled to the encryption/decryption engine.

14. The method of claim 13, wherein the repository is communicatively coupled to the encryption/decryption engine using a network protocol.

15. The method of claim 13, wherein the repository is communicatively coupled to the encryption/decryption engine using a data bus.

16. The method of claim 8, wherein the encryption/decryption engine is implemented via one of source code in a program, linking a library, or executing a separate program on a user accessible computing device.

17. The method of claim 16, wherein linking a library further comprises one of a static link or a dynamic link.

18. The method of claim 8, wherein the first format is cipher text and the second format is clear text.

19. The method of claim 8, wherein the first format is clear text and the second format is cipher text.

20. The method of claim 8, wherein the appropriate access level directs the encryption/decryption engine to translate data using multiple keys.
